(19) United States
(12) Patent Application Publication
(10) Pub. No.: US 2016/0350990 A1
(43) Pub. Date: Dec. 1, 2016

(54) ELECTRONIC LOCK ASSEMBLY AND LOCK THEREOF

(71) Applicant: LINTEX CO., LTD., ZHANGHUA COUNTY (TW)

(72) Inventor: CHIA-SHENG LIN, ZHANGHUA COUNTY (TW)

(21) Appl. No.: 15/164,600

(22) Filed: May 25, 2016

(30) Foreign Application Priority Data
May 26, 2015 (TW) 104208154

(51) Int. Cl. G07C 9/00; E05B 47/00

(52) U.S. Cl. CPC G07C 9/00182; E05B 47/0001; E05B 2047/0084; G07C 2009/0023

(57) ABSTRACT

A lock is provided, including: a main body, including a locking mechanism which is movable; a mechanical driving mechanism, for being operated to dismiss the locking mechanism from a locked state; an electronic unit, disposed on the main body for receiving an unlocking signal from an electronic device, the electronic unit including an electronic driving mechanism; wherein when the electronic unit receives the unlocking signal, the electronic driving mechanism dismisses the locking mechanism from the locked state. An electronic lock assembly is further provided, including the lock mentioned above, the electronic lock assembly further including an electronic device, the electronic device including a signal sending device which is capable of sending the unlocking signal.

### BACKGROUND OF THE INVENTION

1. Field of the Invention

The present invention relates to a lock, and more particularly to an electronic lock assembly and a lock thereof.

2. Description of the Prior Art

Usually, a conventional lock includes a locking mechanism, a lock core and a driving mechanism, and a user can use, for example, a key to drive the driving mechanism so as to comove the lock core to control the locking mechanism to lock or unlock the lock.

However, the structure mentioned above only includes a mechanical unlocking method, and it takes longer time to unlock through this method. The mechanical unlocking method often needs to cooperate with the key; therefore, when the key gets lost, the user cannot unlock the lock. In addition, another unlocking method is needed for different users to use in accordance with different requirements.

The present invention has arisen to mitigate and/or obviate the afore-described disadvantages.

### SUMMARY OF THE INVENTION

The major object of the present invention is to provide an electronic lock assembly and a lock thereof which has a mechanical driving mechanism and an electronic driving mechanism and can be unlocked in two ways so as to prevent the risk that the lock is unable to be unlocked. In addition, sending an unlocking signal through an electronic device can increase the efficiency of unlocking process, and the two locking ways can be used separately by an administrator and a user to have more application possibilities.

To achieve the above and other objects, a lock is provided, including: a main body, including a locking mechanism which is movable; a mechanical driving mechanism, for being operated to dismiss the locking mechanism from a locked state; an electronic unit, disposed on the main body for receiving an unlocking signal from an electronic device, the electronic unit including an electronic driving mechanism; wherein when the electronic unit receives the unlocking signal, the electronic driving mechanism dismisses the locking mechanism from the locked state.

To achieve the above and other objects, an electronic lock assembly is further provided, including the lock mentioned above, the electronic lock assembly further including an electronic device, the electronic device including a signal sending device which is capable of sending the unlocking signal.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a drawing of a first preferred embodiment of the present invention;

FIG. 2 is a diagram of the first preferred embodiment of the present invention;

FIG. 3 is a drawing showing the first preferred embodiment of the present invention in use;

FIG. 4 is a drawing of a second preferred embodiment of the present invention;

FIG. 5 is a drawing of a third preferred embodiment of the present invention; FIG. 6 is a drawing of a fourth preferred embodiment of the present invention;

FIG. 7 is a drawing of a fifth embodiment of the present invention;

FIG. 8 is a drawing of a sixth embodiment of the present invention; and

FIG. 9 is a drawing of a seventh embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

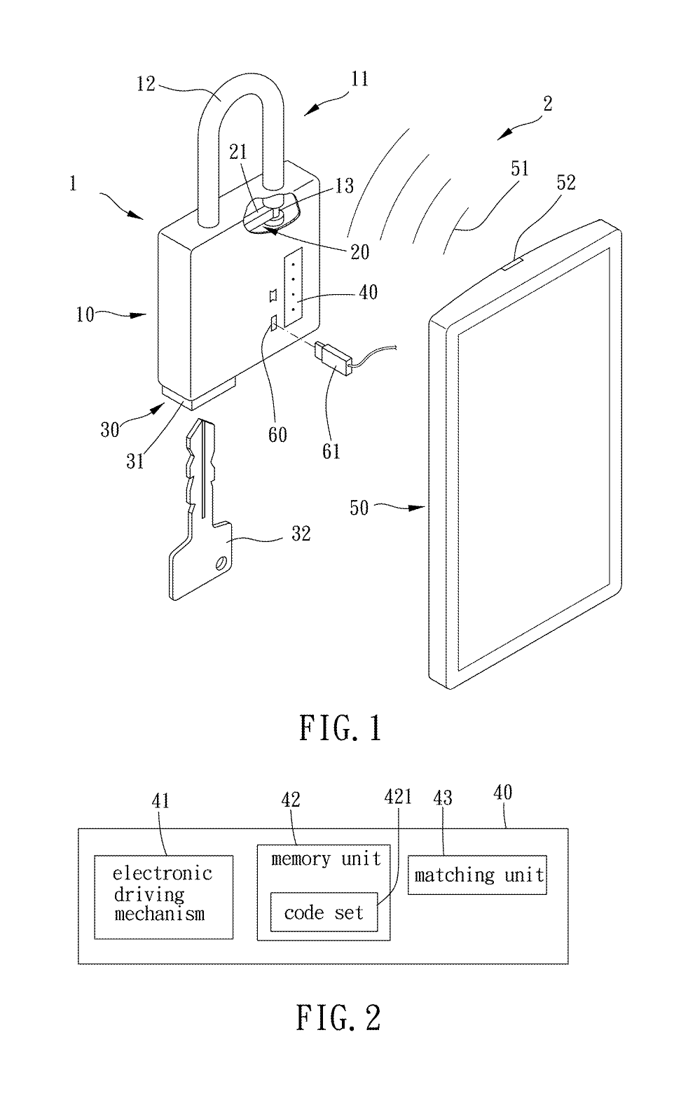

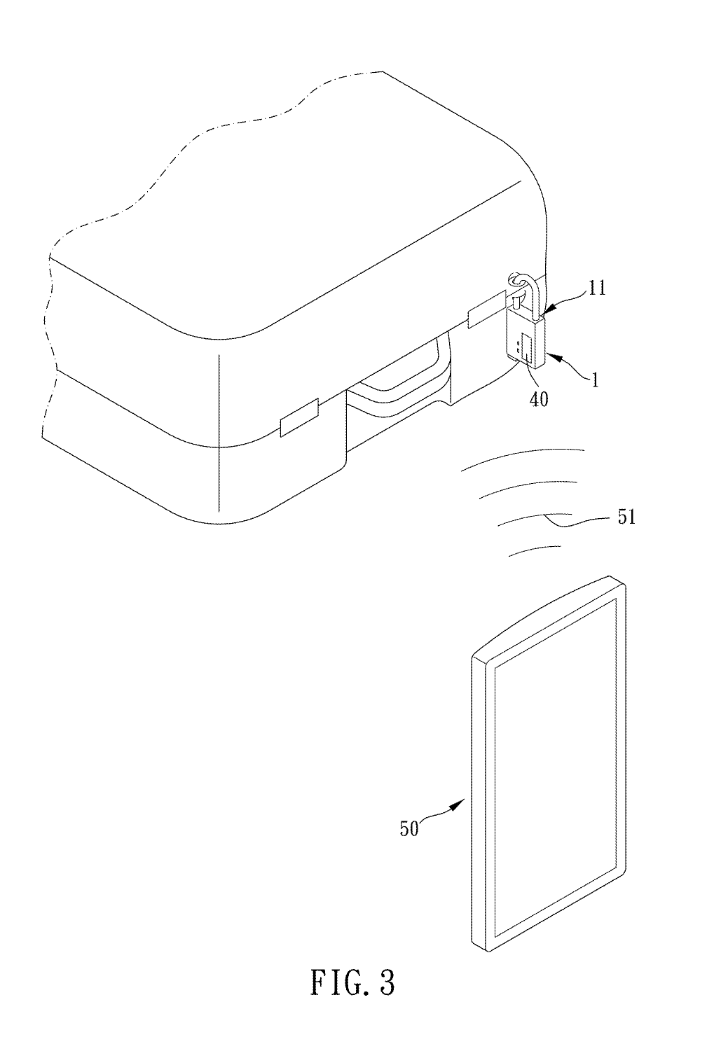

Please refer to FIGS. 1 to 3 for a first preferred embodiment of the present invention. A lock 1 includes a main body 10, a lock core 20, a mechanical driving mechanism 30 and an electronic unit 40.

The main body 10 includes a locking mechanism 11 which is movable. Specifically, in this embodiment, the locking mechanism 11 may include a locking portion 12 (however, in other embodiments, the locking mechanism 11 may include a latch, a supporting member or a transformable member), the locking portion 12 can be provided for locking an object such as a luggage and making the object unable to be opened, and the locking portion 12 may lock or unlock the object through a key member.

The lock core 20 is disposed in the main body 10 and releasably locked by the locking mechanism 11, for example, the locking mechanism 11 may include a recess 13, the lock core 20 may include a protrusive key 21 which is reciprocally movable, and the protrusive key 21 is disengageably engaged with the recess 13 so that the locking mechanism 11 can be locked. Specifically, in this embodiment, the recess 13 may be provided on an end of the locking portion 12, when the protrusive key 21 is engaged with the recess 13, the locking portion 12 can be locked; on the contrary, when the protrusive key 21 is disengaged with the recess 13, the locking portion 12 can be unlocked.

In addition, the mechanical driving mechanism 30 is connected with the lock core 20, and the mechanical driving mechanism 30 may be for being operated to drive the lock core 20 to dismiss the locking mechanism 11 from a locked state. More specifically, when the mechanical driving mechanism 30 is operated, the mechanical driving mechanism 30 may comove the protrusive key 21, and the protrusive key 21 of the lock core 20 may be engaged or disengaged with the recess 13 of the locking portion 12.

For example, the mechanical driving mechanism 30 may be a key mechanism 31 which is rotatably disposed in the main body 10, the key mechanism 31 is for a key member 32 to insert therein, and the key member 32 is for a user to rotate to drive the key mechanism 31 so as to comove the lock core 20 to lock or unlock the locking mechanism 11. In other embodiments, the key mechanism may be configured in a press-type or reciproctable-type such that the key mechanism may lock/unlock the locking mechanism through press or axially displacement of thereof.

The electronic unit 40 is disposed on the main body 10 for receiving an unlocking signal 51 from an electronic device 50, the electronic unit 40 includes an electronic driving mechanism 41, and the electronic driving mechanism 41 is connected with the lock core 20. More specifically, the unlocking signal 51 can be transmitted between the electronic device 50 and the electronic unit 40, the electronic unit 40 may include at least one of a Bluetooth wireless receiving device, a NFC wireless receiving device and a WiFi wireless receiving device which are capable of receiving the unlocking signal 51 so that the unlocking signal 51 can transmit at least one of a Bluetooth wireless signal, a NFC wireless signal and WiFi wireless signal. In addition, the electronic device 50 and the electronic unit 40 can transmit 3G or 4G wireless signals to each other. When the electronic unit 40 receives, for example, the unlocking signal 51 from the electronic device 50, the electronic unit 40 transmits an indication to the electronic driving mechanism 41 to drive the electronic driving mechanism 41, and the electronic driving mechanism 41 drives the lock core 20 to dismiss the locking mechanism 11 from the locked state. On the contrary, when the electronic unit 40 receives a locking signal, the electronic unit 4 drives the electronic driving mechanism 41 to comove the lock core 20 to lock the locking mechanism 11.

The electronic unit 40 may further include a memory unit 42 and a matching unit 43, and the memory unit 42 saves at least one code set 421. Specifically, the memory unit 42 can save the code set 421 which is entered in advance through logical operation, and the code set 421 may be a random combination of Arabic numerals or English letters. The matching unit 43 is for matching the unlocking signal 51 with the code set 421. More specifically, when the electronic unit 40 receives the unlocking signal 51, the matching unit 43 identifies the unlocking signal 51 with the code set 421 saved in the memory unit 42. When the unlocking signal 51 matches the code set 421, the electronic unit 40 can drive the electronic driving mechanism 41 and comove the lock core 20 to unlock the lock; and if the unlocking signal 51 does not match the code set 421, the electronic driving mechanism 41 cannot be driven.

The main body 10 may further include at least one insertion port 60, the insertion port 60 is electrically connected with the electronic unit 40, and the insertion port 60 is for being connected with a power connecting wire 61 (or/and a signal transmitting wire). Specifically, the electronic unit 40 can transmit data through the insertion port 60 and the signal transmitting wire 61 with, for example, a computer. For example, the electronic unit 41 is transmittable with the computer to update programs or codes, and the electronic unit 40 can be charged through the insertion port 60 and the power connecting wire connected with a power socket.

It is to be noted that the lock 1 may drive the lock core 20 to unlock the locking mechanism 11 through the mechanical driving mechanism 30 or the electronic driving mechanism 41 so that the lock 1 can be used in different ways to meet various requirements. For example, the lock 1 can be used on a luggage which needs to pass the customs examination, when a customs officer or an administrator unlocks the lock 1 of the luggage, the customs office can use the electronic device 50 to send the unlocking signal 51 to the lock 1 so as to unlock the luggage, and it is time-saving and efficient for the customs officer to unlock the lock 1. When the user unlocks the lock 1, the user can also use the electronic device 50 to send the unlocking signal 51 to the lock 1. However, when the user is unable to unlock through the electronic device 51 (for example, when the electronic device 50 has insufficient electricity), the user can use the key member 32 to unlock the lock 1.

Please refer to FIGS. 1 to 3, an electronic lock assembly 2 is further provided, including the lock 1 mentioned above. The electronic lock assembly 2 further includes an electronic device 50, the electronic device 50 includes a signal sending device 52 which is capable of sending the unlocking signal. For example, the electronic device 50 may be a mobile phone, the signal sending device 52 may be a

Bluetooth wireless receiving device, a NFC wireless receiving device or a WiFi wireless receiving device, the electronic device 50 may include a controlling system and an input unit which is electrically connected with the controlling system, the input unit may be for the user to enter an input message (for example, an identification data like a code), and the controlling system may have a logical function and be capable of encoding the input message and sending the message which is encoded through the signal sending device out to form the unlocking signal 51 which is received by the lock 1. The controlling system encrypts the input message when the message is encoded or combines the input message with a preset serial number data so as to prevent the input message from being copied or received by others.

It is to be noted that the electronic device 50 may send, for example, an electronic signal to a cloud system, the cloud system may be connected to the electronic device 50 through the Internet, and when the cloud system receives the electronic signal, the cloud system can identify the electronic signal (for example, to verify an identity) and transmit a cloud unlocking signal to the lock 1 so as to unlock the lock 1. Preferably, an identification process is conducted through the cloud system so as to enhance the security of the lock 1.

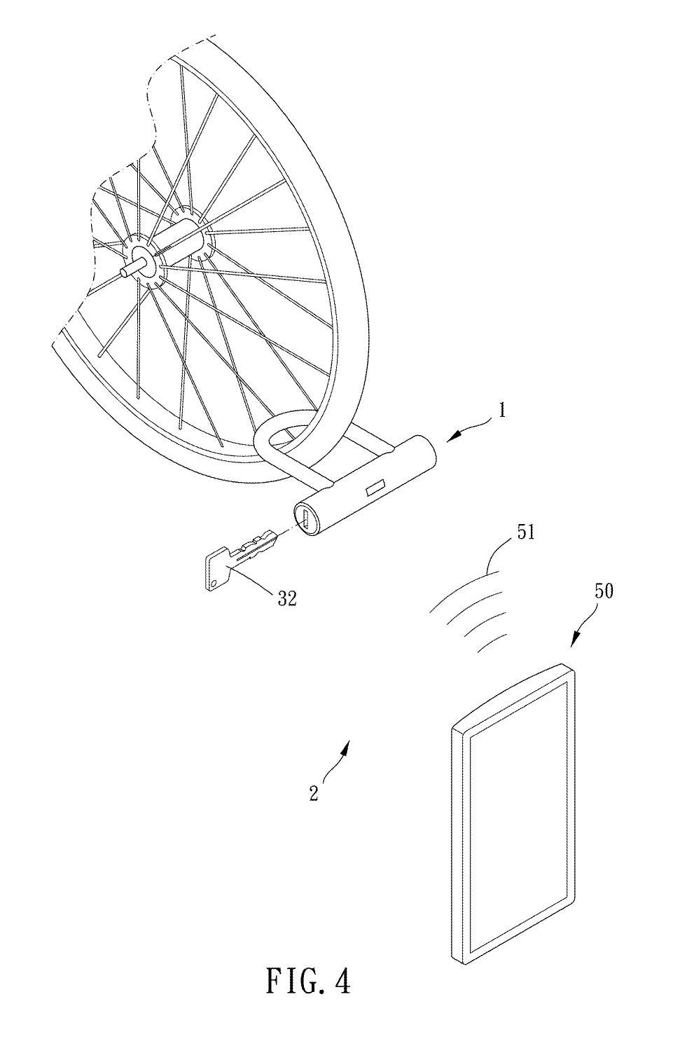

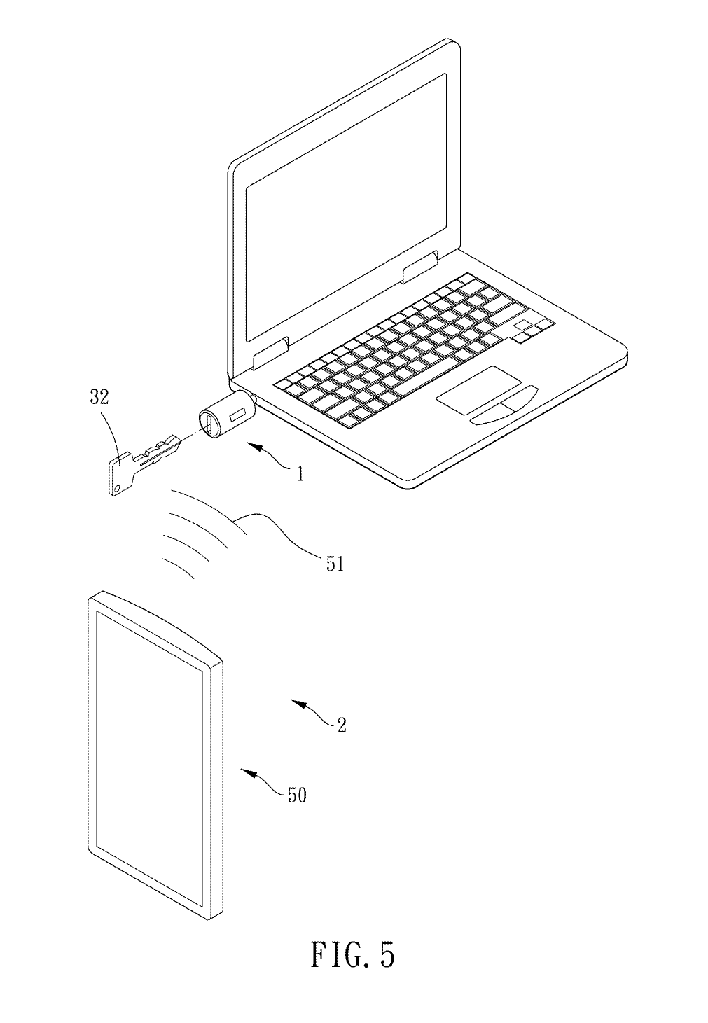

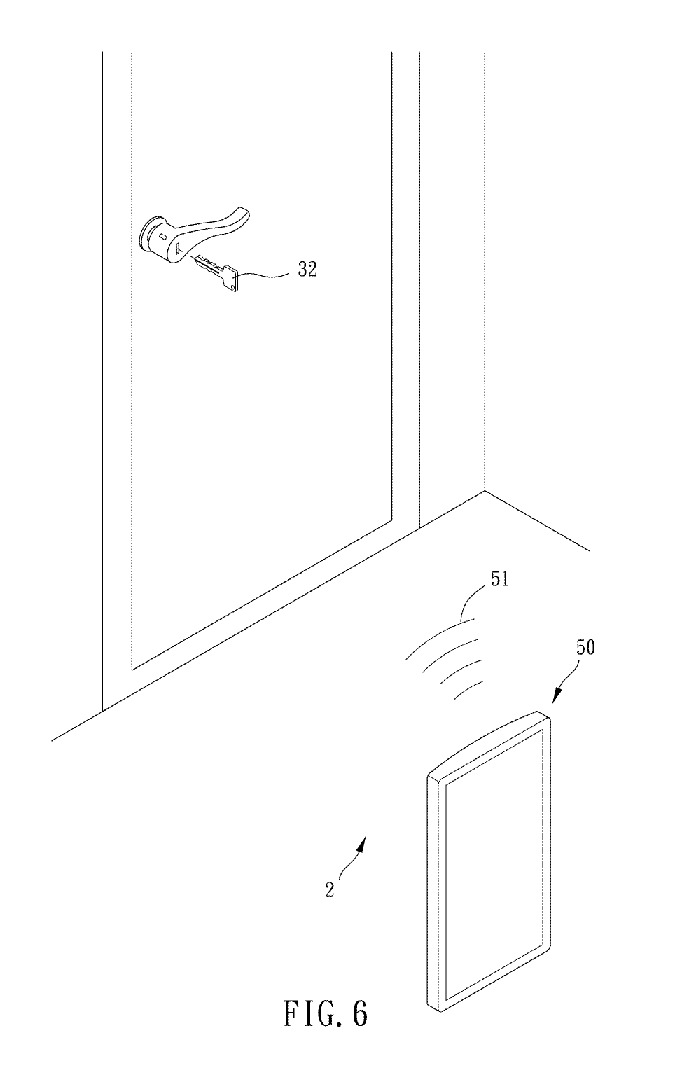

Please further refer to FIGS. 4 to 6. The lock 1 may cooperate with the electronic device 50 to be used in, for example, a bicycle lock (as shown in FIG. 4); the electronic lock assembly 2 may be used in, for example, a notebook lock (as shown in FIG. 5); and the electronic lock assembly 2 may be further used in, for example, a door lock (as shown in FIG. 6).

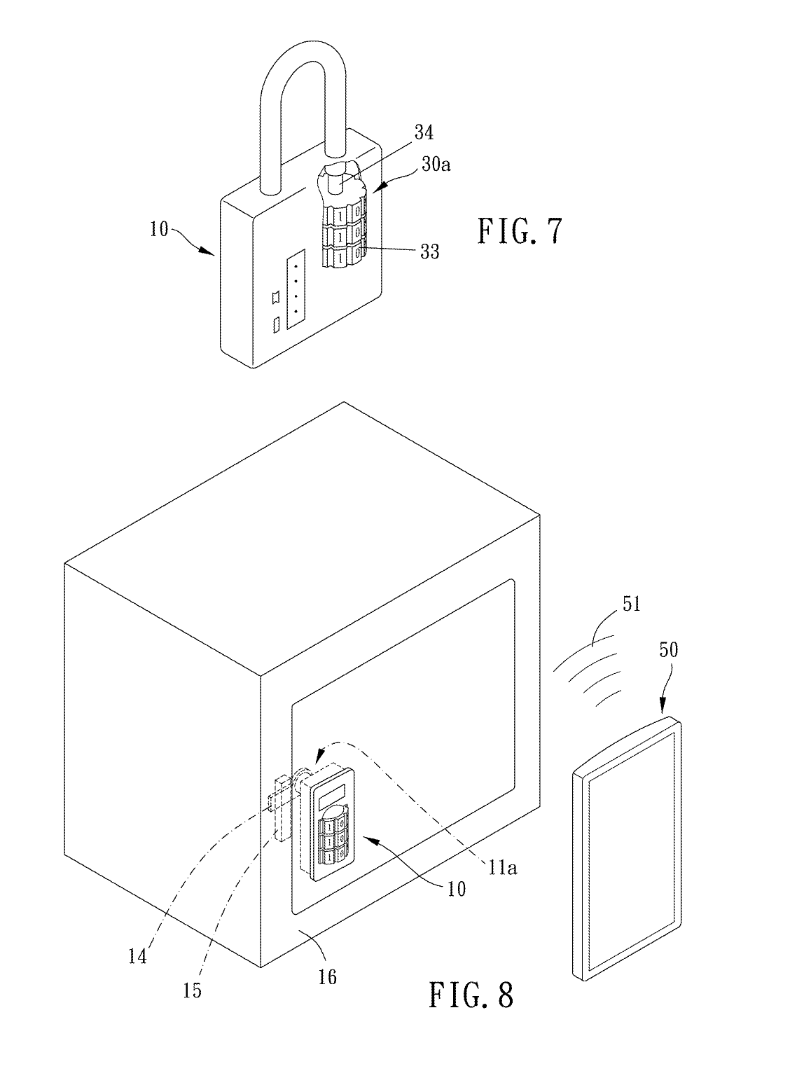

In a fifth embodiment of FIG. 7, the mechanical driving mechanism 30a includes at least one dial 33 which is rotatably disposed in the main body 10 and an axle 34 which is disposed in the main body 10 and inserted into the at least one dial 33, and the axle 34 is connected with the lock core. In a sixth embodiment of FIG. 8, the locking mechanism 11a includes a latch member 14 which is reciprocally movable, an end of the latch member 14 is exposed outside the main body 10 for being disengageably engaged with a groove structure 15, and the groove structure is disposed on an exterior base 16 or the main body 10.

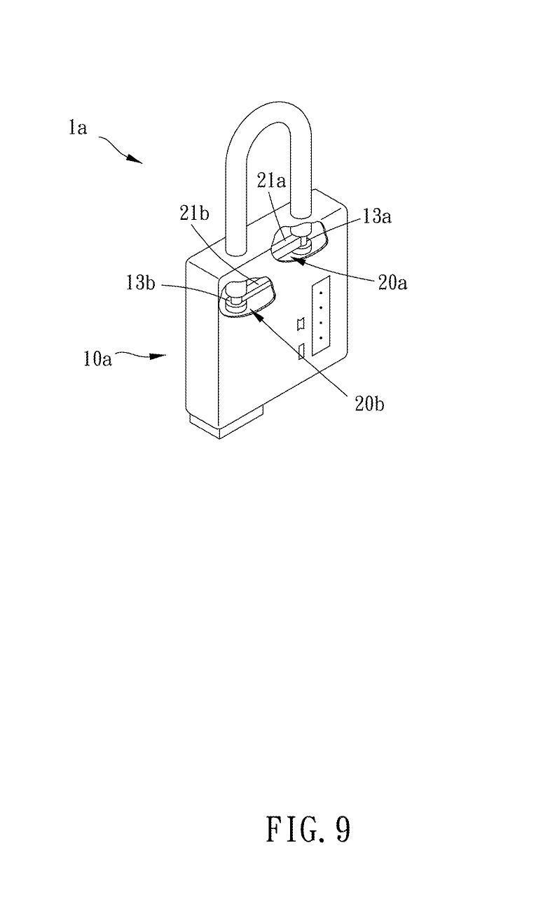

In a seventh embodiment of FIG. 9, the lock la may include two lock cores 20a, 20b which are respectively disposed in the main body 10a, the two lock cores 20a, 20b can be respectively driven by the mechanical driving mechanism and the electronic driving mechanism to unlock or lock the lock. For example, the two lock cores 20a, 20b can respectively drive the protrusive key 21a and the protrusive key 21b to be engaged or disengaged with the recess 13a and the recess 13b so as to unlock or lock the lock.

Given the above, the electronic lock assembly and the lock thereof have the mechanical driving mechanism and the electronic driving mechanism, so the lock can be unlocked in two ways to prevent the risk of being unable to unlock. In addition, the unlocking signal is sent through the electronic device, so it is efficient to unlock the lock. Furthermore, the two unlocking ways can be used respectively by the administrator and the user for more application possibilities.

While we have shown and described various embodiments in accordance with the present invention, it should be clear to those skilled in the art that further embodiments may be made without departing from the scope of the present invention.

What is claimed is:

1. A lock, including:
a main body, including a locking mechanism which is movable;
a mechanical driving mechanism, for being operated to dismiss the locking mechanism from a locked state;
an electronic unit, disposed on the main body for receiving an unlocking signal from an electronic device, the electronic unit including an electronic driving mechanism;
wherein when the electronic unit receives the unlocking signal, the electronic driving mechanism dismisses the locking mechanism from the locked state.

2. The lock of claim 1, further including at least one lock core, the lock core disposed in the main body and releasably locked by the locking mechanism.

3. The lock of claim 1, wherein the mechanical driving mechanism is a key mechanism disposed on the main body.

4. The lock of claim 1, wherein the mechanical driving mechanism includes at least one dial which is rotatably disposed in the main body and an axle which is disposed in the main body and inserted into the at least one dial.

5. The lock of claim 1, wherein the electronic unit includes at least one of a Bluetooth wireless receiving device, a NFC wireless receiving device and a WiFi wireless receiving device which are capable of receiving the unlocking signal.

6. The lock of claim 1, wherein the main body further includes at least one insertion port, the insertion port is electrically connected with the electronic unit, and the insertion port is for being connected with a power connecting wire or/and a signal transmitting wire.

7. The lock of claim 1, wherein the electronic unit further includes a memory unit and a matching unit, the memory unit saves at least one code set, and the matching unit is for matching the unlocking signal of the electronic device with the code set.

8. The lock of claim 2, wherein the locking mechanism includes a recess, the lock core includes a protrusive key which is reciprocally movable, and the protrusive key is disengageably engaged with the recess.

9. An electronic lock assembly, including the lock of claim 1, the electronic lock assembly further including an electronic device, the electronic device including a signal sending device which is capable of sending the unlocking signal.

10. The electronic lock assembly of claim 9, wherein the signal sending device is a Bluetooth wireless receiving device, a NFC wireless receiving device or a WiFi wireless receiving device.
